(19) United States
(12) Patent Application Publication
(10) Pub. No.: US 2015/0220855 A1
(43) Pub. Date: Aug. 6, 2015

(54) INFORMATION PROCESSING APPARATUS, INFORMATION PROCESSING METHOD AND INFORMATION PROCESSING PROGRAM

(71) Applicant: Rakuten, Inc., Tokyo (JP)

(72) Inventor: Ryohei Takuma, Tokyo (JP)

(73) Assignee: Rakuten, Inc., Tokyo (JP)

(21) Appl. No.: 14/420,688

(22) PCT Filed: Mar. 19, 2013
(86) PCT No.: PCT/JP2013/057846

§ 371 Date: Feb. 10, 2015

(51) Int. Cl. G06Q 10/02; H04L 29/08

(52) U.S. Cl. CPC G06Q 10/02; H04L 67/10

(57) ABSTRACT

An information processing apparatus judges, based on a reservation history, a user who is shy to make a reservation of a reservation frame which has not been reserved by any person. The information processing apparatus acquires a browsing history of the reservation frame which has not been reserved by any person and is specified based on a request for the reservation frame information from the first user who is shy to make the reservation of the reservation frame which has not been reserved by any person. The information processing apparatus extracts, based on the browsing history, a second user who has browsed the reservation frame information. The information processing apparatus causes a profile of the second user to be presented to the first user in association with the reservation frame whose reservation frame information has been browsed.

### TECHNICAL FIELD

The present invention relates to a technical field of a system which enables a plurality of users to reserve a reservation frame at which an event to be held.

### BACKGROUND ART

There has conventionally been known a service which enables a plurality of users to reserve individually a reservation frame at which an event is to be held by a plurality of persons. For example, Patent Document 1 discloses a technique for reservation of a golf course.

### CITATION LIST

### Patent Document

Patent Document 1: Japanese Patent Provisional
Publication No. 2012-138003

### SUMMARY OF INVENTION

### Technical Problem

In the service as described above, a plurality of users who reserved a certain reservation frame will participate together in an event at the reserved reservation frame. Therefore, when a user reserves a reservation frame which has not reserved by any person, the user does not know what type of users the user will participate together with in the event. So, there may exist a user who hesitates to reserve the reservation frame which has not been reserved by any person yet.

An object of the present invention, which was made in view of the above-described problems, is to provide an information processing apparatus, an information processing method and an information processing program which can provide a user with information for making a decision of reservation so that user does not hesitate to reserve a reservation frame which has not been reserved by any person.

### Solution to Problem

In order to solve the above problem, the invention according to claim 1 is an information processing apparatus comprising: a judgment means that judges, based on a reservation history of a reservation frame of an event in which a plurality of users can participate, a user who is shy to make a reservation of a reservation frame which has not been reserved by any person, the reservation history being stored in a reservation history storage means storing a reservation history of each reservation frame so that order of users who has reserved the reservation frame can be specified; an acquisition means that acquires, from a browsing history storage means storing a browsing history including information indicating a user who has browsed reservation frame information on the reservation frame, a browsing history of a reservation frame which has not been reserved by any person and which is specified based on a request, for the reservation frame information, from a first user who is judged by the judgment means to be shy to make the reservation of the reservation frame which has not been reserved by any person; an extract means that extracts, based on the browsing history acquired by the acquisition means, a second user who has browsed the reservation frame information of the reservation frame specified based on the request, from among other users than the first user; and a control means that causes at least a part of a profile of the second user extracted by the extract means to be presented to the first user in association with the reservation frame whose reservation frame information has been browsed by the second user.

According to the present invention, a profile of another user who browsed reservation frame information of a reservation frame which has not been reserved by any person is presented to a user who is shy to make a reservation of a reservation frame which has not been reserved by any person, in association with this reservation frame. A user who has browsed reservation frame information of a certain reservation frame has a higher probability of desiring to reserve this reservation frame than another user who has not browsed the reservation frame information of this reservation frame. Therefore, the user who is shy to make the reservation of the reservation frame, which has not been reserved by any person, can know what type of person another user who may participate together with the user in an event is. Thus, according to the present invention, it is possible to provide a user with the information for making a decision of reservation so that user does not hesitate to reserve a reservation frame which has not been reserved by any person.

The invention according to claim 2 is the information processing apparatus according to claim 1, further comprising: an output means that when the reservation frame which had not been reserved by any person was reserved by a third user who is different from the first user after the first user browsed the reservation frame information of the reservation frame, outputs a notification information of informing the first user that the reservation frame has been reserved.

According to the present invention, when a reservation frame which had not been reserved by any person, corresponding to the reservation frame information browsed by the user, who was shy to reserve a reservation frame which has not been reserved by any person, was reserved by someone, this user is informed that this reservation frame was reserved. Therefore, it is possible to encourage the user who is shy to reserve a reservation frame which has not been reserved by any person to make the second or subsequent reservation.

The invention according to claim 3 is the information processing apparatus according to claim 2, further comprising: a priority order determination means that, when a number of first users who browsed the reservation frame information of the reservation frame which has been reserved by the third user, prior to the reservation of the reservation frame, is larger than a number of users who can currently reserve the reservation frame, determines priority order of the first users who are to be informed that the reservation frame has been reserved, and wherein: the output means outputs the notification information based on the priority order determined by the priority order determination means.

According to the present invention, when the number of users who browsed the reservation frame information is larger than the number of users who can reserve the reservation frame corresponding to this reservation frame information, notice is made according to priority order of the users. Therefore, it is possible to avoid a case where a user cannot make a reservation, in spite of receiving information, due to the fact that the number of users who have reserved this reservation frame has amounted to the maximum number of participants.

The invention according to claim 4 is the information processing apparatus according to claim 3, wherein: the event is a game played by a plurality of users; and the information processing apparatus further comprising a skill information acquisition means that acquires, from a skill information storage means storing skill information indicating skills of users at the game, skill information of the first users and skill information of the third user, and wherein: the priority order determination means determines, based on the skill information acquired by the skill information acquisition means, the priority order so that a first user having a level of the skills which is the same as a level of the skills of the third user is preferentially informed.

According to the present invention, a user having the level of the skills which are the same as the level of the skills of another user at the game who made a reservation is preferentially informed. Therefore, when the user who received preferentially the information made the reservation, the users who have the same level of skills at the game can play the game together. It is therefore possible to provide a higher probability of making a reservation, while avoiding a case where the user who received the information cannot make a reservation.

The invention according to claim 5 is the information processing apparatus according to claim 3 or 4, further comprising: an operation history acquisition means that acquires, from an operation history storage means storing an operation history of a user on a website in which a reservation frame available can be searched for, operation histories of the first users; and an tenacity degree determination means that determines, based on the operation histories acquired by the operation history acquisition means, tenacity degrees of the first users for at least any one of a place where the event corresponding to the reservation frame reserved by the third user is to be held and a time when the event is to be started, wherein: the higher an tenacity degree determined by the tenacity degree determination means for a first user is, the higher priority the priority order determination means determines for the first user.

According to the present invention, there is determined an tenacity degree indicating that to what extent the user is insisting on a place where the event is to be held through the reserved reservation frame, or to what extent the user is insisting on a time when the event corresponding to the reserved reservation frame is to be held. Then, the information is presented in descending order of tenacity degrees. It is therefore possible to provide a higher probability of making a reservation, while avoiding a case where the user who received the information cannot make a reservation.

The invention according to claim 6 is an information processing method to be executed by a computer comprising: a judgment step of judging, based on a reservation history of a reservation frame of an event in which a plurality of users can participate, a user who is shy to make a reservation of a reservation frame which has not been reserved by any person, the reservation history being stored in a reservation history storage means storing a reservation history of each reservation frame so that order of users who has reserved the reservation frame can be specified; an acquisition step of acquiring, from a browsing history storage means storing a browsing history including information indicating a user who has browsed reservation frame information on the reservation frame, a browsing history of a reservation frame which has not been reserved by any person and which is specified based on a request, for the reservation frame information, from a first user who is judged in the judgment step to be shy to make the reservation of the reservation frame which has not been reserved by any person; an extract step of extracting, based on the browsing history acquired in the acquisition step, a second user who has browsed the reservation frame information of the reservation frame specified based on the request, from among other users than the first user; and a control step of causing at least a part of a profile of the second user extracted in the extract step to be presented to the first user in association with the reservation frame whose reservation frame information has been browsed by the second user.

The invention according to claim 7 is an information processing program to be executed to cause a computer to function as: a judgment means that judges, based on a reservation history of a reservation frame of an event in which a plurality of users can participate, a user who is shy to make a reservation of a reservation frame which has not been reserved by any person, the reservation history being stored in a reservation history storage means storing a reservation history of each reservation frame so that order of users who has reserved the reservation frame can be specified; an acquisition means that acquires, from a browsing history storage means storing a browsing history including information indicating a user who has browsed reservation frame information on the reservation frame, a browsing history of a reservation frame which has not been reserved by any person and which is specified based on a request, for the reservation frame information, from a first user who is judged by the judgment means to be shy to make the reservation of the reservation frame which has not been reserved by any person; an extract means that extracts, based on the browsing history acquired by the acquisition means, a second user who has browsed the reservation frame information of the reservation frame specified based on the request, from among other users than the first user; and a control means that causes at least a part of a profile of the second user extracted by the extract means to be presented to the first user in association with the reservation frame whose reservation frame information has been browsed by the second user.

### Advantageous Effect of Invention

According to the present invention, a profile of another user who browsed reservation frame information of a reservation frame which has not been reserved by any person is presented to a user who is shy to make a reservation of a reservation frame which has not been reserved by any person, in association with this reservation frame. A user who has browsed reservation frame information of a certain reservation frame has a higher probability of desiring to reserve this reservation frame than another user who has not browsed the reservation frame information of this reservation frame. Therefore, the user who is shy to make the reservation of the reservation frame, which has not been reserved by any person, can know what type of person another user who may participate together with the user in an event is. Thus, according to the present invention, it is possible to provide a user with the information for making a decision of reservation so that user does not hesitate to reserve a reservation frame which has not been reserved by any person.

### BRIEF DESCRIPTION OF DRAWINGS

FIG. 1 is a view showing an example of a schematic configuration of an information processing system S according to one embodiment of the present invention.

FIG. 2A is an example of display of a time frame selection page in a case where a single person reservation frame is specified as a kind of frame, and FIG. 2B is an example of display of a time frame detail page.

FIG. 3 is a sequence diagram showing a processing example of the information processing system S according to one embodiment of the present invention.

FIG. 4A is an example of display of the time frame selection page of a non-reserved frame for a user who is shy to make the first reservation, and FIG. 4B is an example of display of the time frame detail page of the non-reserved frame, for the user who is shy to make the first reservation.

FIG. 5A is a sequence diagram showing a processing example of the information processing system S according to one embodiment of the present invention, and FIG. 5B is an example of a body of a reservation notification mail.

FIG. 6A is a block diagram showing an example of a schematic configuration of a golf course reservation server 1 according to one embodiment of the present invention, and FIG. 6B is an example of a function block of the golf course reservation server 1 according to the embodiment of the present invention.

FIG. 7A is a view showing an example of contents to be registered in a member information DB 12a, FIG. 7B is a view showing an example of contents to be registered in a golf course information DB 12b, FIG. 7C is a view showing an example of contents to be registered in an reservation situation DB 12c, FIG. 7D is a view showing an example of contents to be registered in a reservation information DB 12d, and FIG. 7E is a view showing an example of contents to be registered in an operation history DB 12e.

FIG. 8 is a flowchart showing a processing example of a time frame selection page sending processing, by a system control unit 14 of the golf course reservation server 1 according to the embodiment of the present invention.

FIG. 9 is a flowchart showing a processing example of a time frame detail page sending processing, by the system control unit 14 of the golf course reservation server 1 according to the embodiment of the present invention.

FIG. 10 is a flowchart showing a processing example of a reservation processing by the system control unit 14 of the golf course reservation server 1 according to the embodiment of the present invention.

FIG. 11A is a flowchart showing a processing example of a priority order determination processing in a case where a priority order is determined based on skills of the user at golf, and FIG. 11B is a flowchart showing a processing example of the priority order determination processing in a case where the priority order is determined based on operation histories.

FIG. 12 is a flowchart showing a processing example of a reservation notification control processing by the system control unit 14 of the golf course reservation server 1 according to the embodiment of the present invention.

### EMBODIMENTS FOR CARRYING OUT THE INVENTION

Now, the embodiment of the present invention will be described below with reference to the drawings. The embodiment of the present invention as described below is an embodiment to which the present invention is applied to the information processing system.

### [1. Summary of Configuration and Functions of Information Processing System]

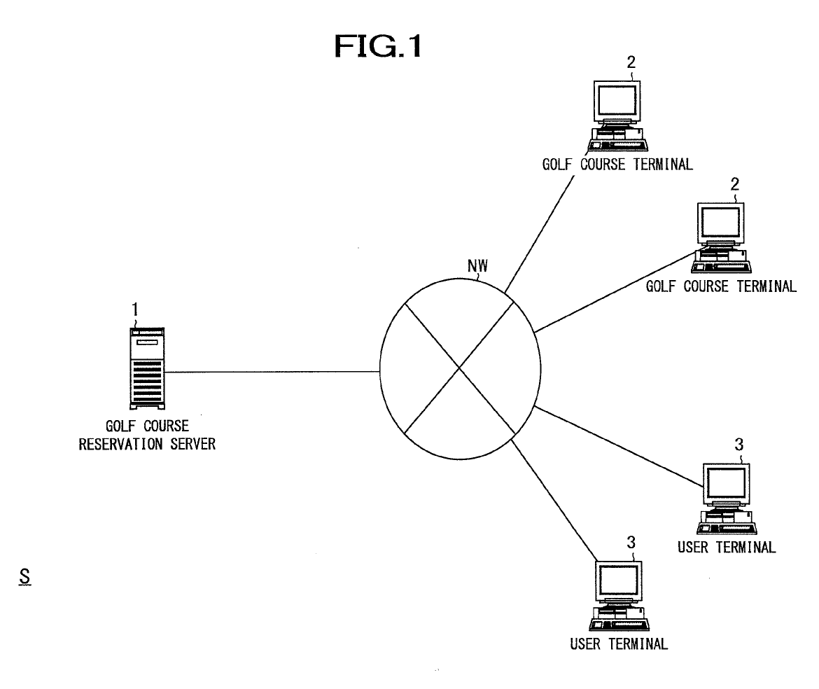

Now, the configuration of the information processing system according to the embodiment of the present invention will be described with reference to FIG. 1. FIG. 1 is a view showing an example of a schematic configuration of the information processing system S according to the embodiment of the present invention.

As shown in FIG. 1, the information processing system S includes a golf course reservation server 1, a plurality of golf course terminals 2 and a plurality of user terminals 3. It is possible to send or receive mutually data among the golf course reservation server 1, each golf course terminal 2 and each user terminal 3 through a network NW, e.g., with the use of a TCP/IP as a communication protocol. The network NW is constructed by for example an Internet, a dedicated communication line (e.g., a CATV (Community Antenna Television) line), a mobile communication network (including a base station, etc.), a gateway, and the like.

The golf course reservation server 1 is a server device that performs various kinds of processing for a reservation site in which golf courses are reserved. The golf course reservation server 1 is indicated as an example of the information processing apparatus of the present invention. A user may use the reservation site to reserve use of a golf course they desire. The golf course reservation server 1 may, for example, send a web page on a reservation site, or execute a processing regarding search, reservation, etc. of a golf course in response to a request from the user terminal 3. Golf is indicated as an example of the event in the present invention. The golf course is indicated as an example of a place in which the event is held in the present invention. The reservation site is indicated as an example of a website in the present invention.

The golf course terminal 2 is a terminal device which may be used by a golf course provider who provides a golf course. The golf course terminal 2 has access to server devices such as the golf reservation server 1 based on an operation by the golf course provider. This may cause the golf course terminal 2 to receive information on the web page from the server device. The golf course terminal 2 includes installed software for a browser, an electronic mail client, etc. The golf course provider may use the golf course terminal 2 to check a situation of reservation at the golf course as provided by the golf course provider and change the reservation.

The user terminal 3 is a terminal device of a user who uses a reservation site. The user terminal 3 may have access to the golf course reservation server 1 based on an operation by the user and receive the web page from the golf course reservation server 1 to display it. The user terminal 3 includes installed software for a browser, an electronic mail client, etc. As the user terminal 3, there may be used for example a personal computer, a handheld information terminal such a PDA (Personal Digital Assistant) and a smartphone, a cellular phone, etc.

### [2. Single Person Reservation Frame]

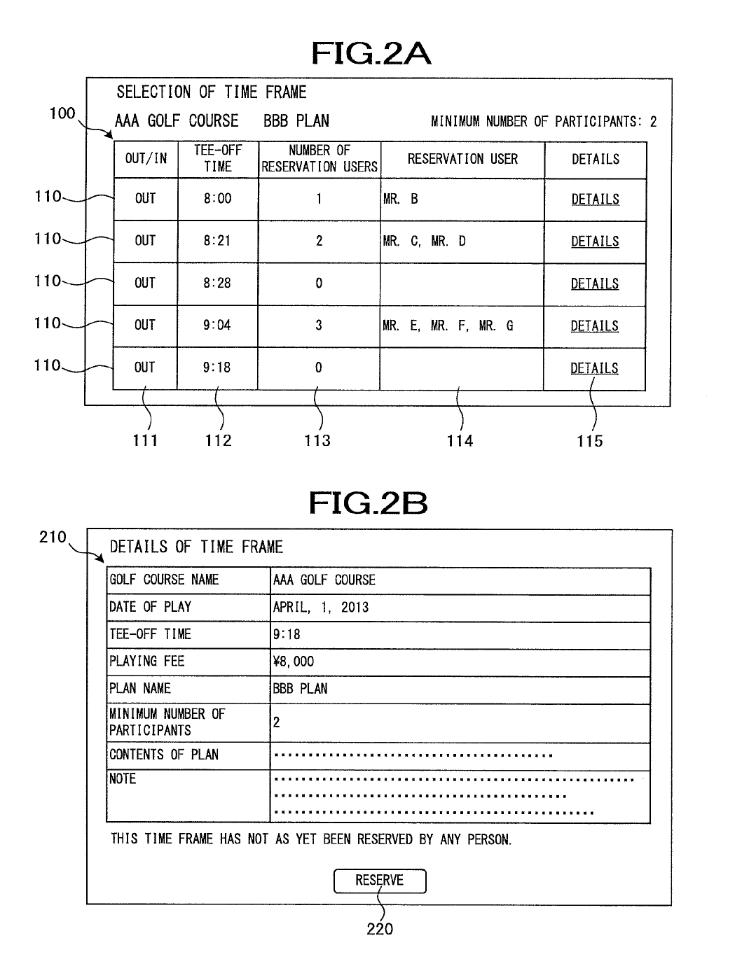

Now, a single person reservation frame will be described with reference to FIG. 2. In order to reserve a golf course in a reservation site, a user specify a time when a golf play is to be started. This time may be referred to as the “tee-off time”. A plurality of tee-off times is set for a front nine and a back nine of each golf course. In addition, an interval between the adjacent tee-off times is set for a golf course of each golf course. A period of time from a certain tee-off time to the next tee-off time may be referred to as the “time frame”. The time frame is indicated as an example of the reservation frame in the present invention. The time frames of this embodiment of the present invention are associated with golf courses of golf courses. Through the time frame corresponding to the tee-off time specified by a user, the user may reserve a golf course and a front nine or a back nine which correspond to this time frame. Then, it is made a plan that a game of golf is to be started within the reserved time frame.

There are kind of time frames including a normal time frame and a single person reservation time frame. The golf course reservation server 1 may be configured so that, for example, the golf course provider can set the time frame, in which the golf course is to be provided, as any one of the normal time frame and the single person reservation time frame in each time frame.

The normal time frame is defined as a time frame which can be reserved to permit a group consisting of at least two persons to play golf. For example, a representative of the group may reserve the normal time frame on the reservation website.

The single person reservation time frame is a time frame which can be reserved by a single user. A plurality of users may reserve one single person reservation time frame. A plurality of users who have reserved a certain single person reservation time frame will play golf together. The number of users who have reserved a certain single person reservation frame may be referred to as the “number of reservation users”. The minimum number of participants by which the event can be held and the maximum number of participants by which the event can be held have previously been set for the single person reservation frame. The minimum number of participants by which the event can be held is defined as a requirement to hold an event of golf at the single person reservation frame. More specifically, the minimum number of participants by which the event can be held is the minimum number of players which is required to hold the event of golf. That is, the single person reservation frame is the minimum value of the number of reservation users for holding the event of golf. The minimum number of participants by which the event can be held may be set for example to 2 or more. The single person reservation frame in which the number of current reservation users is equal to or larger than the minimum number of participants by which the event can be held may be referred to as the “event holding conditions-satisfying reservation frame”. The single person reservation frame in which the number of current reservation users is equal to or larger than one and smaller than the minimum number of participants by which the event can be held may be referred to as the “user-shortage-reservation frame”. The single person reservation frame in which the current number of reservation users is 0 may be referred to as the “non-reserved frame”. More specifically, the non-reserved frame is a time frame which has not been reserved by any person.

The golf course reservation server 1 may determine for example if the number of reservation users is equal to or larger than the minimum number of participants by which the event can be held, at a predetermined time on a day before the date of play in the reserved single person reservation frame. This time may be referred to as the “holding-event-determination time”. The holding-event-determination time may be for example twelve noon, etc. When the golf course reservation server 1 judges that the number of reservation users is equal to or larger than the minimum number of participants by which the event can be held, the server determines the event of golf to be held. In this case, the golf course reservation server 1 sends an electronic mail to each user reserving the single person reservation frame to inform them that the event of golf is to be held, for example. On the other hand, when the golf course reservation server 1 judges that the number of reservation users is smaller than the minimum number of participants by which the event can be held, the server determines the event of golf not to be held. In this case, the golf course reservation server 1 performs a processing of cancelling the reservation of the single person reservation frame. Then, the golf course reservation server 1 sends an electronic mail to each user reserving the single person reservation frame to inform them that the number of reservation users is smaller than the minimum number of participants by which the event can be held, and the reservation has automatically be cancelled, for example.

The maximum number of participants by which the event can be held is the number of users can play golf through the single person reservation frame. Accordingly, users the number of whom is equal to or smaller than the maximum number of participants by which the event can be held may reserve a single person reservation frame. The maximum number of participants by which the event can be held may be set for example to 2 or more. The maximum number of participants by which the event can be held may be for example four. At least one of the minimum number and the maximum number of participants by which the event can be held may freely be set by a golf course provider, for example. The same minimum numbers of participants by which the event can be held and the same maximum numbers of participants by which the event can be held may be set in all the time frames in one golf course. Or, the minimum number and the maximum number of participants by which the event can be held may be set in each of the time frames. In this case, there may be a difference in at least one of the minimum number of participants by which the event can be held and the maximum number of participants by which the event can be held, between some time frames. Alternatively, the same minimum number of participants by which the event can be held and the same maximum number of participants by which the event can be held may previously be set throughout the whole reservation site.

The user may input various search conditions when searching for a golf course on the reservation site. The golf course reservation server 1 searches for golf courses for which available reservation plans are provided, under the specified search conditions. The plan is a service including the providing of a golf course. The plan is to be made for example by a golf course provider. The search conditions may include for example a date of play, a range of charges, a region, a desired tee-off time period, a name of golf course, a kind of frame, etc. The date of play is a date on which a game of golf is to be played in a golf course. The desired tee-off time period is a period of time in which a user wishes to start a game of golf. The desired tee-off time period may be specified for example in a manner of designating a period between nine and ten o'clock, a period between ten to eleven o'clock, etc. The kind of frame indicates whether the time frame to be searched for is the normal time frame or the single person reservation frame.

When a golf course has been found, a golf course search result page is displayed on a screen of the user terminal 3. On the golf course search result page, there is displayed a list of found golf course, as the search results of the golf course. When the user has selected a desired golf course in the list, the golf course page is displayed on the screen of the user terminal 3. The golf course page includes information, as displayed, about the selected golf course. In addition, on the golf course page, there is displayed a list of plans which satisfies the search conditions in the selected golf course. When the user has selected a combination of a plan and a date of play on the golf course page, the golf course reservation server 1 searches for available time frames in the selected combination. This permits to make a search for the available time frames on the reservation site. When the desired tee-off time period has been specified as the search condition, the golf course reservation server 1 searches for available time frames in the desired tee-off time period which is specified, for example. In a case where the kind of frame is the single person reservation frame, the available time frames is the single person reservation frame in which the number of reservation users is smaller than the maximum number of participants by which the event can be held.

When the time frame has been found, the time frame selection page is displayed on the screen of the user terminal 3. On the time frame selection page, there is displayed a list of found time frames, as the search results of the time frames. The time frame selection page is an example of the reservation frame information of the present invention. FIG. 2A is an example of display of the time frame selection page in a case where a single person reservation frame is selected as a kind of frame. The time frame selection page includes a search result region 100, as shown in FIG. 2A. The search result region 100 includes time frame information 110, as displayed, for each found single person reservation frame. The time frame information 110 includes a front/back nine indicator 111, a tee-off time 112, the number of current reservation users 113, a list of reservation users 114 and a particulars-link 115, as displayed. The list of reservation users 114 is a list of users reserving the single person reservation frame indicated by the tee-off time 112. The list of reservation users 114 includes for example a nickname of the user as displayed. The list of reservation users 114 may include for example an image, as displayed, of a face indicative of the user. The particulars-link 1115 is a hyper-link to the time frame detail page. When a user selects a detail link 115, the time frame detail page is displayed on the screen of a user terminal 3. The time frame detail page is an example of the reservation frame information of the present invention.

The time frame detailed page is a webpage on which the detailed information on the single person reservation frame is displayed. FIG. 2B is an example of display of the time frame detail page. The time frame detail page includes a time frame detail region 210, a reservation button 220, etc., as shown in FIG. 2B. The time frame detail region 210 includes a golf course name, a date of play, a tee-off time, a playing fee, a plan name, the minimum number of participants by which the event can be held, the contents of plan, a note, etc., as displayed. The reservation button 220 is a button for making a reservation of a single person reservation frame whose information is presented on the time frame detail page. The time frame detail page as shown in FIG. 2B is a time frame detail page of the non-reserved frame.

When one or more users reserving the single person reservation frame exist, the time frame detail page further includes a profile, as displayed, of the user making the reservation. There are displayed, as the profile, for example the user's nickname, age, gender, level of golf, playing style, self-introduction, spirit, etc. The level of golf is indicative of a skill of golf. The level is indicated for example in the form of an average of scores of the games of golf previously played. The playing style, the self-introduction, the spirit, etc. are inputted by the user, for example, when the user reserves the single person reservation frame.

### [3. Presentation of Profile of User Browsing Information of Non-Reserved Frame]

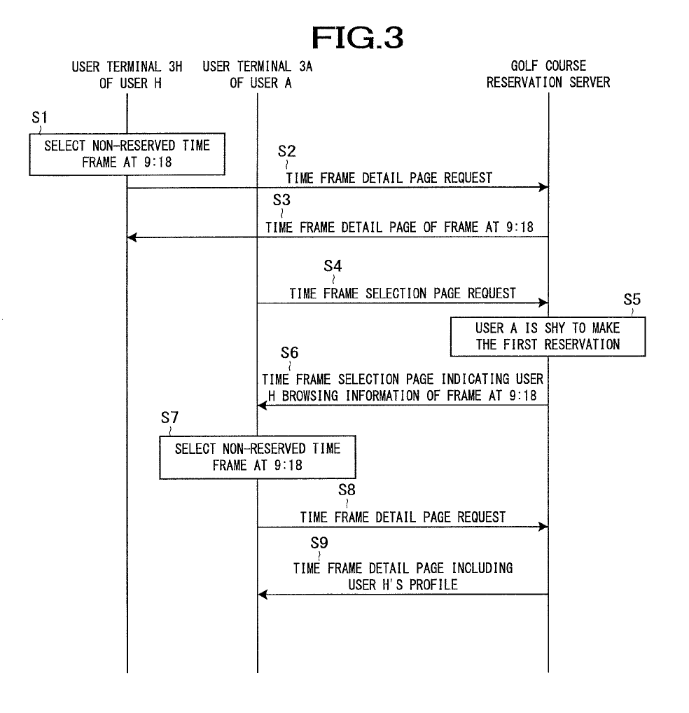

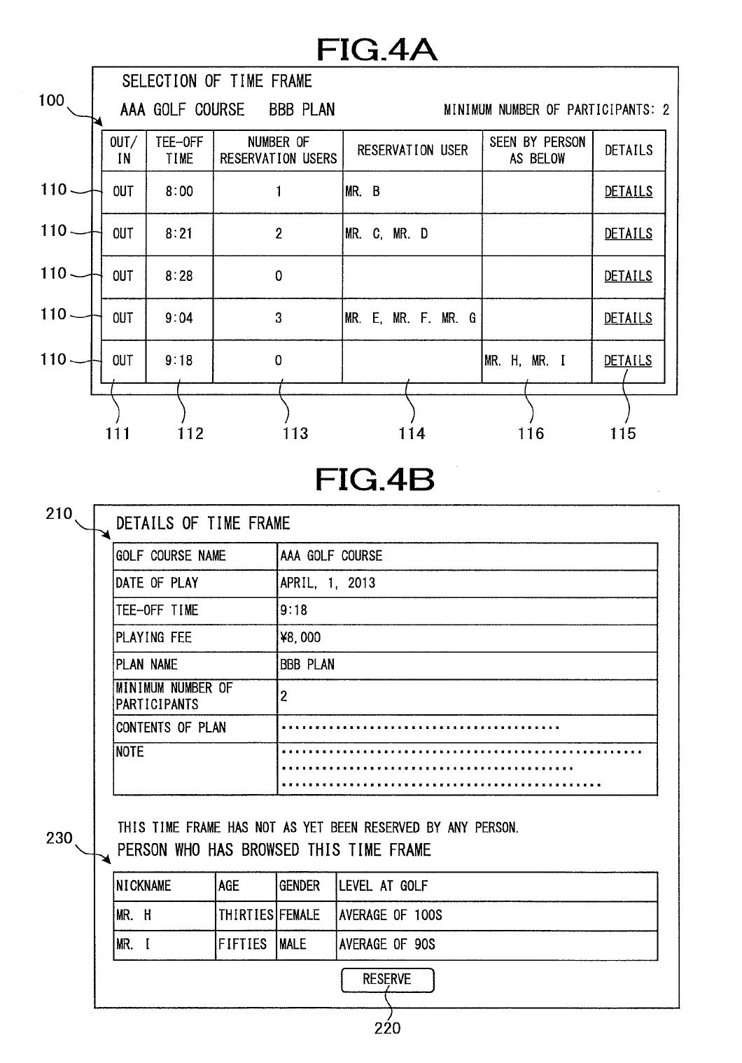

Now, the presentation of a profile of a user who has browsed information of a non-reserved frame will be described with the use of FIG. 3 and FIG. 4. Making a reservation of a single person reservation frame first may be referred to as the “first reservation”. Namely, reserving a non-reserved frame is the first reservation. The non-reserved frame is a time frame which has not as yet been reserved by any person. If a user has reserved a non-reserved frame, the user does not know, at the time of the reservation, with whom the user will play golf. Therefore, the user may hesitate to make the first reservation. For these reasons, there may exist a user who can easily make a reservation of the time frame which has already been reserved by any person, but is shy to make the first reservation. The user who is shy to make the first reservation, may include, for example, a user who is apt to hesitate to make the first reservation, a user who is apt to avoid the first reservation, a user who hates to make the first reservation, etc. The golf course reservation server provides information for making a decision of reservation so that a user who is shy to make the first reservation does not hesitate to make the first reservation.

The golf course reservation server 1 judges if a user is shy to make the first reservation, based on the reservation information. The reservation information is information indicating the contents of reservation of a golf course. The golf course reservation server 1 registers the reservation information every time the reservation has been made. The reservation information is also a history of the reservation. The golf course reservation server 1 calculates a rate of the first reservation made by a user, of past reservations of the single person reservation frame by users, based on the reservation history of the user. When the rate of making the first reservation is less than a preset threshold value, the golf course reservation server 1 judges the user as a user who is shy to make the first reservation. The user who is to be judged if they are shy to make the first reservation is an example of the first user of the present invention.

When the user who is shy to make the first reservation browses a time frame detail page of a non-reserved frame, the golf course reservation server 1 causes the user terminal 3 to present, to user, at least a part of a profile of another user who browsed the time frame detail page of the non-reserved frame, in association with this non-reserved frame. The other user who browsed the time frame detail page of the non-reserved frame is an example of the second user of the present invention. A user who has browsed a time frame detail page has a probability of desiring to playa game through the time frame corresponding to this time frame detail page. Therefore, the user who has browsed the time frame detail page has a probability of considering stronger to make the reservation of the time frame corresponding to this time frame detail page, than another user who has not browsed this time frame detail page. The user who is shy to make the first reservation can know information about the other user having a probability of making the reservation, by viewing the profile of the other user, who has browsed the time frame detail page. Therefore, the user who is shy to make the first reservation can judge if the user should browse the non-reserved frame, based on the profile of the other user. It is possible to encourage more strongly the user who is shy to make the first reservation to make the first reservation than in the case where the profile of the other user is not presented.

Now, a general description of the processing of the information processing system S will be given. FIG. 3 is a sequence diagram showing a processing example of the information processing system S according to the embodiment of the present invention. It is assumed that, for example, a user A is shy to make the first reservation and a user H is not shy to make the first reservation. The user H operates the user terminal 3H to search for a golf course. It is assumed that the time frame selection page on February 1 in a plan Y of a golf course X is then displayed on a screen of the user terminal 3H. For example, the time frame selection page as shown in FIG. 2A is displayed. It is assumed that the user H has selected the detail link 115 of the non-reserved frame, for example, at 9:18 from the time frame selection page (Step S1). Then, the user terminal 3H sends a time frame detail page request to the golf course reservation server 1 (Step S2). The time frame detail page request is a message indicating a request for the time frame detail page. In response to the time frame detail page request, the golf course reservation server 1 sends the time frame detail page of the non-reserved frame at 9:18 to the user terminal 3H (Step S3). At this time, the golf course reservation server 1 registers a browsing history. The browsing history is a history of browsing a web page. The time frame detail page as shown for example in FIG. 2B is displayed on the screen of the user terminal 3H.

After that, the user A operates the user terminal 3A to search for a golf course. It is assumed that the golf course page of the golf course X is then displayed on the user terminal 3A. It is assumed that the user A has selected the combination of the plan Y and the date of February 1, from the golf course page. Then, the user terminal 3A sends a time frame selection page request. The time frame selection page request is a message indicating a request for the time frame selection page (S4).

The golf course reservation server 1, which has received the time frame selection page, judges the user A as a user shy to make the first reservation (Step S5). Incidentally, the step of judging if the user is the user shy to make the first reservation, based on the reservation information, may be carried out at any time. When taking the reservation processing, the golf course reservation server 1 may judge if the user making the reservation is the user shy to make the first reservation, based on the reservation information of the user making the reservation. In addition, the golf course reservation server 1 may previously set a flag, etc., indicating judgment results. After that, when receiving the time frame selection page request, the golf course reservation server 1 may judge if the user who will browse the time frame selection page is the user shy to make the first reservation, based on the set flag, etc. Alternatively, when receiving the time frame selection page request, the golf course reservation server 1 may make a judgment based on the reservation information of the user who will browse the time frame selection page.

The golf course reservation server 1, which has judged the user A as the user shy to make the first reservation, sends the time frame selection page. In this case, the golf course reservation server 1 sends, based on the browsing history, a time frame selection page which includes information indicating that the time frame detail page of the non-reserved frame at 9:18 has been browsed by the user H, etc. (Step S6). FIG. 4A is an example of display of the time frame selection page of the non-reserved frame for the user who is shy to make the first reservation. As shown in FIG. 4A, in the time frame information 110 of the non-reserved frame whose time frame detail page has been browsed, a front/back nine indicator 111, a tee-off time 112, the current number of reservation users 113, a reservation user list 114, a detail link 115 and a browsing user list 116 are displayed. The browsing user list 116 is displayed when the time frame indicated by the tee-off time 112 is the non-reserved frame. The browsing user list 116 is a list of users who have browsed the time frame detail page of the non-reserved frame indicated by the tee-off time 112. For example, in the browsing user list 116, nicknames of the users may be displayed. The example in FIG. 4A shows that the time frame detail page of the non-reserved frame at 8:28 has not been browsed by any person yet. This also shows that the users H and I have browsed the time frame detail page of the non-reserved frame at 9:18. In the browsing user list 116, images of faces indicating the users may be displayed. Alternatively, the time frame selection page may not include for example the browsing user list 116. Instead, it is only necessary to display information indicating that the time frame detail page of the non-reserved frame has been browsed by someone, in this time frame information 110 of the non-reserved frame.

When the user A has selected the detail link 115 of the non-reserved frame at 9:18 (Step S7), the user terminal 3A sends the time frame detail page request (Step S8). The golf course reservation server 1, which has received the time frame detail page request, sends a time frame detail page including a profile of the user H, etc., to the user terminal 3A (Step S9). In addition, the golf course reservation server 1 registers a browsing history.

FIG. 4B is an example of display of the time frame detail page of the non-reserved frame, for the user who is shy to make the first reservation. As shown in FIG. 4B, the time frame detail page includes a time frame detail region 210, a reservation button 220, and a profile region 230. In the profile region, a profile of a user who has browsed the time frame detail page. For example, a nickname, an age, a gender, a golf level, etc. are displayed as the profile.

The items included in the profile are not limited only to the nickname, the age, the gender and the golf level of a user. In the browsing user list 116 of the time frame selection page, the profile (for example, an age, a gender, a golf level) of the user who has browsed the time frame detail page, for example. In this case, the time frame detail page may not include the profile region 230.

### [4. Notification of Reservation of the Non-Reserved Frame]

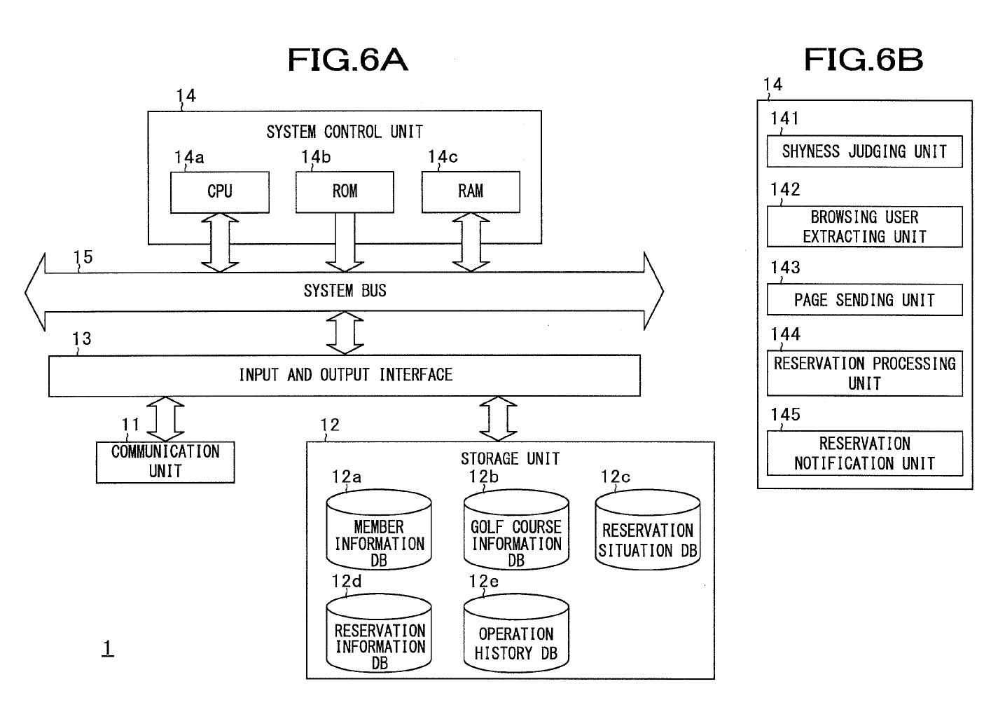

Now, notification to a user who is shy to make the first reservation in a case where a non-reserved frame has been reserved will be described below with FIG. 6. When a user who is shy to make the first reservation has browsed a time frame detail page of the non-reserved frame, this user has a probability of desiring to play a game through this non-reserved frame. However, there may be a case where the user, who is shy to make the first reservation, does not reserve this non-reserved frame. So, when someone has reserved the non-reserved frame corresponding to the time frame detail page which was browsed by the user, who was shy to make the first reservation, the golf course reservation server 1 informs the user, who is shy to make the first reservation, of the fact that the frame has been reserved. This makes it possible to encourage the user, who is shy to make the first reservation, to make the second or subsequent reservation of the time frame which the user probably wants to reserve. In addition, it is possible to reduce the number of cases where a user who is shy to make the first reservation may lose the chance of making the reservation. A time frame for which a notification indicating that the first reservation has been made is performed may be referred to as the “notification subjected frame”. The user who has reserved the non-reserved frame is an example of the third user of the present invention.

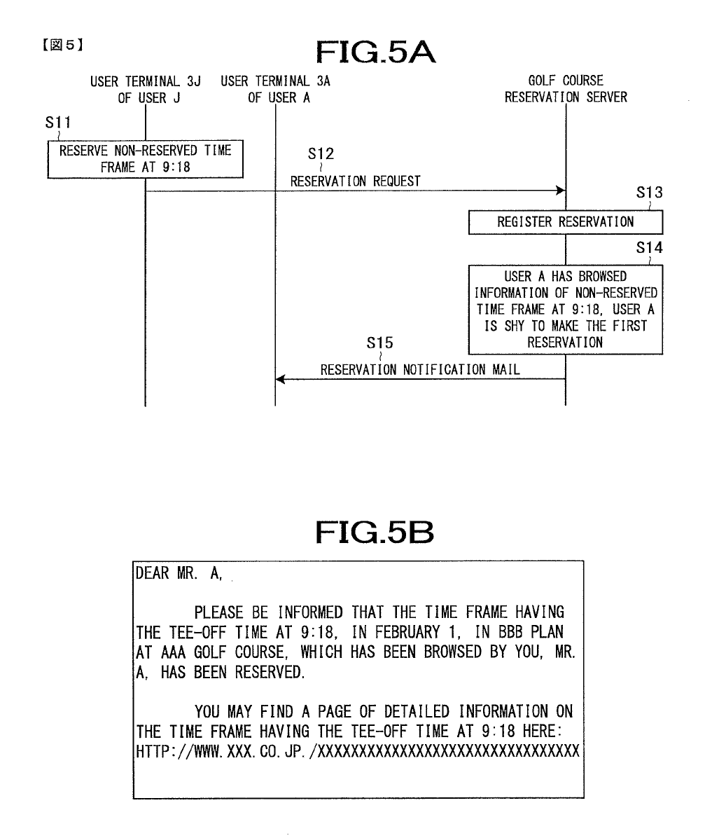

A general description of the processing of the information processing system S will be given below. FIG. 5A is a sequence diagram showing a processing example of the information processing system S according to the embodiment of the present invention. It is assumed that the user A has not made a reservation, after the processing as shown in FIG. 3. It is assumed that, on the other hand, a user J has operated the user terminal 3J to reserve the non-reserved frame at 9:18 (Step S11). Then, the user terminal 3J used by the user J sends a reservation request to the golf course reservation server 1 (Step S12). The reservation request is a message indicating a request for reservation. The golf course reservation server 1 registers the reservation information based on the reservation request (Step S13). Then, the golf course reservation server 1 specifies, based on the browsing history, the user A, etc. as the user who has browsed the time frame detail page of the time frame at 9:18. In addition, the golf course reservation server 1 judges the user A as the user who is shy to make the first reservation (Step S14). In this case, the golf course reservation server 1 outputs a notification information informing the user A that the time frame at 9:18 has been reserved (Step S15). The golf course reservation server 1 may send for example an electronic mail as the notification information informing of the reservation. This electronic mail may be referred to as the “reservation notification mail”. The reservation notification mail is an example of the notification information of the present invention.

FIG. 5B is an example of a body of the reservation notification mail. As shown in FIG. 5B, in the reservation notification mail, a message informing that the time frame whose information was browsed by the user who is shy to make the first reservation has been reserved, a tee-off time of the notification subjected frame, a URL of the time frame detail page of the notification subjected frame may be described.

Alternatively, the golf course reservation server 1 may provide the notification information through the web page of the reservation site. The reservation site includes a web page in which there are displayed histories indicating that the user browsed information of a golf course, a front/back nine, etc. on the reservation site. This web page may be referred to as the “browsing history page”. The golf course reservation server 1 may generate the browsing history page in which, for example, the message informing that the notification subjected frame has been reserved, a URL of the time frame detail page of the notification subjected frame, etc. are displayed in association with the golf course, the front/back nine, the date of play, the tee-off time, etc.

For the notification subjected frame, the reservation from at least one user may be received at the time when the first reservation was made. The number of users who can reserve a certain time frame at the present moment may be referred to as the “number of users who can make reservation of time frame”. The difference between the maximum number of participants by which the event can be held and the number of reservation users is the number of users who can make reservation of time frame. The number of users who are shy to make the first reservation, of users who have browsed a time frame detail page of a notification subjected frame before the first reservation of the notification subjected frame was made, may be referred to as the “number of browsing users of non-reserved frame”. There is a case where the number of browsing users of non-reserved frame is larger than the number of users who can make reservation of time frame of the notification subjected frame. In this case, the golf course reservation server 1 may inform, for example, all the users who are shy to make the first reservation that the reservation has been made. However, in this case, at least one of the users who have informed cannot make the reservation. So, the golf course reservation server 1 may determine, for the users who are shy to make the first reservation, a priority order of notification and browsed the time frame detail page of the non-reserved frame. Then, the golf course reservation server 1 may, for example, carry out the notification according to the priority order.

The golf course reservation server 1 may carry out the notification, for example, in descending order of priority of the users. In this case, the golf course reservation server 1 may provide a predetermined number of users with the notification information at every time when a predetermined time elapses. The interval of the notification and the number of users subjected to the notification may be freely determined. The golf course reservation server 1 may provide one user at a time with the notification information. The golf course reservation server 1 may not provide any notification information after the number of users who can make reservation of time frame of the notification subjected frame has reached “0”. The reason for it is that the user cannot reserve the notification subjected frame, even if the user receives the notification information. Alternatively, upon the first provision of notification information, the golf course reservation server 1 may provide users the number of whom corresponds to the number of users who can make reservation of time frame of the notification subjected frame, with the notification information. Alternatively, the golf course reservation server 1 may provide the notification information at every time when the reservation of the notification subjected frame has been made, without providing the notification information at every time when a predetermined time elapses.

There are many kinds of methods of determining the priority order. The golf course reservation server 1 may randomly determine the priority order, for example. Alternatively, the golf course reservation server 1 may determine the priority order based on, for example, skills of the users at golf. The golf course reservation server 1 may determine the priority order so as to inform preferentially a user who has the same level of skills as the user who has made the first reservation of the notification subjected frame. For example, a plurality of ranges of skills may previously have been set. So, the golf course reservation server 1 may determine the priority order so as to inform preferentially a user who has the skills within the same range of skills as the user who have made the first reservation of the notification subjected frame. Alternatively, the closer the skills of a user who is shy to make the first reservation is to the skills of the user who has made the first reservation of the notification subjected frame, the higher priority the golf course reservation server 1 may determine, for example. The golf course reservation server 1 may use, for example, an average score, etc., as the skills. The golf course reservation server 1 may be configured for example so that, when the user has played golf, the score may be registered in the reservation site. Then, the golf course reservation server 1 may calculate the average score based on registered scores. Alternatively, the golf course reservation server 1 may be configured for example so that the user may register an average score. The average score is an example of the skill information of the present invention.

In addition, the golf course reservation server 1 records operation histories of the user in the reservation site. The operation histories include a search history of a golf course, a browsing history of a web page, etc. So, the golf course reservation server 1 may determine, based on the operation history, a degree of the user's mind of desiring to start the play of golf through the notification subjected frame. This degree of mind may be referred to as the “tenacity degree”. More specifically, the tenacity degree means a degree of the user's mind of desiring to start the play of golf, for example, in a golf course, on a date of play, at a tee-off time, etc. corresponding to the notification subjected frame. The golf course reservation server 1 may make a comparison in tenacity degree between the respective users, to determine a higher priority for a user having the higher tenacity degree.

For example, when searching for a golf course, a user can designate a name of the golf course, a date of play, a desired tee-off time period, etc. as conditions under which the user desires to play golf. So, the golf course reservation server 1 may determine an tenacity degree of a user whose search conditions correspond to the notification subjected frame to be higher than an tenacity degree of a user whose search conditions do not correspond to the notification subjected frame.

In addition, there is a probability that the user may search for, on the reservation website, information on a golf course in which a user desires to play golf, information on a date when the user desires to play golf, and information on the time frame in which the user desires to play golf. For example, a user who has browsed only information on the notification subjected frame, and the information on the golf course and the date of play corresponding to the notification subjected frame, may have a higher probability of desiring to play golf through the notification subjected frame, than that of a user who has also browsed information of the other time frame than the notification subjected frame or also browsed information on a golf course and a date of play not corresponding to the notification subjected frame. So, the golf course reservation server 1 may judges the user having the higher rate of browsing the web page on which the information corresponding to the notification subjected frame, of the web pages as browsed by the users, is displayed, as having the higher tenacity degree.

So, the higher a rate of browsing the web page on which the information corresponding to the notification subjected frame, of web pages as browsed by a user, is displayed is, the higher the golf course reservation server 1 may determine an tenacity degree of the user to be. The golf course reservation server 1 may determine the tenacity degree for at least one of, for example, the golf course, the date of play and the time frame, or may determine the tenacity degree for the combination of two or more of the golf course, the date of play and the time frame. The golf course reservation server 1 may, for example, combine a plurality of methods to determine the priority order.

### [5. Configuration of Golf Course Reservation Server]

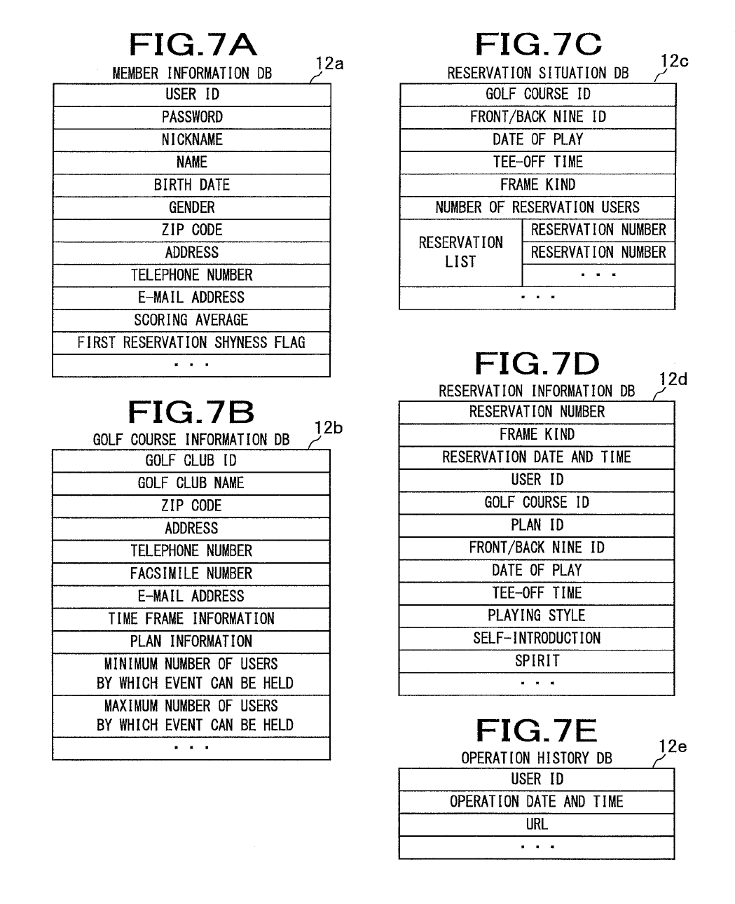

Now, a configuration of the golf course reservation server 1 will be described with reference to FIG. 6 and FIG. 7.

FIG. 6A is a block diagram showing an example of a schematic configuration of the golf course reservation server 1 according to the embodiment of the present invention. As shown in FIG. 6A, the golf course reservation server 1 includes a communication unit 11, a storage unit 12, an input and output interface 13 and a system control unit 14. The system control unit 14 and the input and output interface 13 are connected to each other through a system bus 15.

The communication unit 11 is configured to be connected to the network NW to control communication conditions with the golf course terminals 2, the user terminals 3, etc.

The storage unit 12 includes for example a hard disc drive, etc. The storage unit 12 is an example of the reservation history storage means, the browsing history storage means, the skill information storage means, and the operation history storage means of the present invention. In this storage unit 12, databases are established which include a member information DB 12a, a golf course information DB 12b, a reservation situation DB 12c, a reservation information DB 12d, an operation history DB 12e, etc. “DB” is an abbreviation for database.

FIG. 7A is a view showing an example of contents to be registered in the member information DB 12a. In the member information DB 12a, member information of the users who have registered as a member of the information processing system S is registered. More specifically, In the member information DB 12a attributes of the users which include a user ID, a password, a nickname, a name, a birth date, a gender, Zip code, an address, a telephone number, an E-mail address, a scoring average, a first reservation shyness flag, etc. are registered in association with each other. The first reservation shyness flag indicates if a user is the user who is shy to make the first reservation. When the first reservation shyness flag is set to “TRUE”, the user is shy to make the first reservation. On the other hand, when the first reservation shyness flag is set to “FALSE”, the user is not shy to make the first reservation. The default vale of the first reservation shyness flag is for example “FALSE”. That is, when a user has not as yet reserved a single person reservation frame, the golf course reservation server 1 judges that the user is not shy to make the first reservation. In this embodiment of the present invention, the golf course reservation server 1 judges if a user who has made the reservation is shy to make the first reservation based on the reservation information, when the reservation has been made. Then, the golf course reservation server 1 sets the first reservation shyness flag to a result of the judgment.

FIG. 7B is a view showing an example of contents to be registered in the golf course information DB 12b. In the golf course information DB 12b, golf course information on the golf course is registered. More specifically, In the golf course information DB 12b, attributes of the golf course which include a golf course ID, a golf course name, Zip code, an address, a telephone number, a facsimile number, an E-mail address, the minimum number of participants by which the event can be held, the maximum number of participants by which the event can be held, a time frame information, a plan information, etc. are registered in association with each other. The golf course ID is identification information of the golf course. The time frame information is information on time frames which have been set by a golf course provider. For example, in the time frame information, tee-off times of the respective time frames set for a day. The plan information is information on a plan provided by a golf course provider. The minimum number of participants by which the event can be held and the maximum number of participants by which the event can be held which have been registered in the golf course information DB 12b are the minimum number of participants by which the event can be held and the maximum number of participants by which the event can be held which have been set for all the time frames in the golf course identified by the golf course ID.

FIG. 7C is a view showing an example of contents to be registered in the reservation situation DB 12c. In the reservation situation DB 12c, a reservation situation of each golf course is registered. More specifically, in the reservation situation DB 12c, a golf course ID, a front/back nine id, a date of play, a tee-off frame kind, etc. are registered in association with the respective time frame for each time frame. The front/back nine ID is identification information of each of a front nine and a back nine. The tee-off time is indicative of the time frame. The frame kind is indicative of a kind of the time frame. Any one of the “normal time frame” and the “single person reservation frame” is to be selected as the frame kind. When the “normal time frame” is selected as the frame kind, a reservation flag, etc. is further registered in the golf course information DB 12b. The reservation flag is indicative of if the time frame has been reserved. When the “single person reservation frame” is selected as the frame kind, the numbers of reservation users, a reservation list, etc. are further registered in the golf course information DB 12b. The number of reservation users is the number of users who have currently reserved the single person reservation frame. The reservation list is a list of users who have reserved the single person reservation frame. The reservation list includes the reservation numbers allotted to the reservation users. The reservation number is an identification number to be issued every time the reservation has been completed. The reservation number registered in the reservation user list is an identification number to be issued when a user has reserved the single person reservation frame. The golf course reservation server 1 may search the reservation information DB 12d with the reservation number to specify the user who has reserved the single person reservation frame. Incidentally, the number of reservation users is not necessarily registered in the reservation situation DB 12c. The reason for it is that the golf course reservation server 1 can acquire the number of reservation users by counting the number of the reservation numbers registered in the reservation list.

FIG. 7D is a view showing an example of contents to be registered in the reservation information DB 12d. In the reservation information DB 12d, reservation information is registered which is indicative of reservation contents of the golf course. The reservation information is information indicative of a history of reservation. More specifically, in the reservation information DB 12d, a reservation number, a frame kind, a reservation date and time, a user ID, a golf course ID, a plan ID, a front/back nine id, a date of play, a tee-off time, a playing style, a self-introduction, a spirit are registered in association with each other. The reservation number is information for identifying the reservation information. The frame kind indicates a kind of a reserved time frame. The reservation date and time is a date and time at which the reservation has been made. The user ID is indicative of a user who made the reservation. The golf course ID, the plan ID and the front/back nine ID indicates a golf course, a plan and a front nine or a back nine which are reserved. The tee-off time is indicative of a reserved time frame. The playing style, the self-introduction and the spirit are information which has been inputted by the user who made the reservation.

FIG. 7E is a view showing an example of contents to be registered in the operation history DB 12e. In the operation history DB 12e operation history of the user in the reservation site is registered. In the operation history DB 12e, a user ID, an operation date and time, a URL, etc. are registered in association with each other. The golf course reservation server 1 registers the operation history every time the user operates the user terminal 3 to cause the user terminal 3 to send a request to the golf course reservation server 1. The user ID is indicative of a user who made the operation. The operation date and time is a date and time at which the operation was made. The URL is set in the request from the user terminal 3. The golf course reservation server 1 can specify contents of operation from the URL. The user's operations on the reservation site may include, for example, a search requesting operation of a golf course, a browsing operation of a webpage, a reservation operation, a logging-in operation to a reservation site, a logging-out operation, etc. The history of search requesting operation is a search history. The URL included in the search history includes search conditions inputted by a user. The history of the browsing operation of the webpage is a browsing history. The URL included in the browsing history of the time frame detail page include, as information for specifying the time frame, for example, a golf course ID, a plan ID, a front/back nine id, a date of play, a tee-off time, etc.

Now, the other information to be stored in the storage unit 12 will be described. In the storage unit 12, various kinds of data is stored which includes HTML documents, XML (Extensible Markup Language) documents, image data, text data, electronic documents, etc., for displaying web pages. In addition, in the storage unit 12, various kinds of set values, threshold values, constants, etc. are stored.

In addition, In the storage unit 12, various kinds of programs are stored which include an operating system, a WWW (World, Wide Web) server program, a DBMS (Database Management System), a reservation management program, etc. The reservation management program is a program to execute various kinds of processing about the reservation of a golf course. The reservation management program is an example of the information processing program of the present invention. The various kinds of programs may be acquired for example through the network NW from the other server device, etc., or may be recorded in a record medium such as a DVD (Digital Versatile Disc) so as to be read in through a drive device. In addition, the reservation management program may be a program product. The input and output interface 13 is configured to perform an interface processing between the communication unit 11 and the storage unit 12, on the one hand, and the system control unit 14, on the other hand.

FIG. 6B is an example of a function block of the golf course reservation server 1 according to the embodiment of the present invention. The system control unit 14 includes a CPU 14a, a ROM (Read Only Memory) 14b, a RAM (Random Access Memory) 14c, etc. The CPU 14a reads out various kinds of programs and executes them, to cause the system control unit 14 to function as a shyness judging unit 141, a browsing user extracting unit 142, a page sending unit 143, a reservation processing unit 144, a reservation notification unit 145, etc., as shown in FIG. 6B. The shyness judging unit 141 is an example of the judgment means of the present invention. The browsing user extracting unit 142 is an example of the acquisition means and the extract means of the present invention. The page sending unit 143 is an example of the control means of the present invention. The reservation notification unit 145 is an example of the output means, the priority order determination means, the skill information acquisition means, the operation history acquisition means and the tenacity degree determination means of the present invention.

The shyness judging unit 141 judges, based on the reservation information registered in the reservation information DB 12d, if a user is the user who is shy to make the first reservation. When shyness judging unit 141 has judged the user as the user who is shy to make the first reservation, the browsing user extracting unit 142 extracts a user who browsed the time frame detail page of the non-reserved frame, based on the browsing history registered in the operation history DB 12e. In this case, the browsing user extracting unit 142 extracts the other user than the user who was judged as being shy to make the first reservation. The page sending unit 143 sends the data of the web page of the reservation site to the user terminal 3. Here, the page sending unit 143 sends the time frame detail page including the profile of the user extracted by the browsing user extracting unit 142, to the user terminal 3 used by the user who was judged as being shy to make the first reservation. The reservation processing unit 144 executes a processing of reserving the time frame based on the reservation request from the user terminal 3. When the non-reserved frame has been reserved, the reservation notification unit 145 sends the reservation notification mail to the user who is shy to make the first reservation and has browsed the time frame detail page of this no-reserved frame before this reservation. When the number of browsing users of the non-reserved frame is larger than the number of users who can make reservation of time frame, the reservation notification unit 145 determines the priority order of the users to whom the reservation notification mail is to be sent.

Incidentally, the golf course reservation server 1 may include a plurality of server devices. For example, a server device that searches for the golf course and the time frame on the reservation site, a server device that performs a reservation processing, a server device that sends a webpage of the reservation site in response to a request from the user terminal 3, a server device that send an electronic mail, a server device that manages database, etc. may be connected to each other through a LAN, etc.

### [6. Operation of Information Processing System]

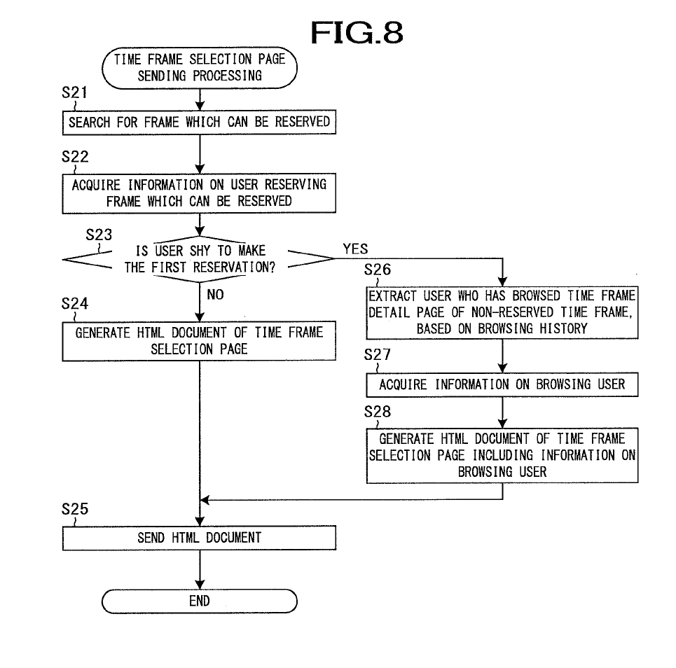

Now, the operation of the information processing system S will be described with reference to FIGS. 8 to 12. Only the processing for the single person reservation frame will be described below and the description of the processing for the ordinary frame will be omitted. In an actual case, the golf course reservation server 1 may change the processing contents in response to the kind of frame selected as the search condition by a user.

FIG. 8 is a flowchart showing the processing example of the time frame selection page sending processing, by the system control unit 14 of the golf course reservation server 1 according to the embodiment of the present invention. The system control unit 14 executes, when receiving the time frame selection page request from the user terminal 3, the time frame selection page sending processing. The user who uses the user terminal 3 sending the request may be referred to as the “request user”. The time frame selection page request includes, for example, a golf course ID, a plan ID, a front/back nine ID, a date of play, a desired tee-off time period, a user ID of the request user, etc. The golf course ID indicates the golf course which has been selected by the request user on the golf course search result page. The plan ID indicates the plan which has been selected by the request user on the golf course page. The front/back nine ID indicates a front nine or a back nine corresponding to the plan which has been selected by the request user on the golf course page. The date of play is a date which has been selected by the request user on the golf course page. The desired tee-off time period is a search condition which has been specified by the request user. The time frame selection page request is an example of the request of the present invention.

As shown in FIG. 8, the page sending unit 143 searches for time frames which can be reserved (Step S21). More specifically, the page sending unit 143 searches the reservation situation DB 12c for tee-off times in which the number of reservation users is less than the maximum number of participants by which the event can be held, from among tee-off times which are associated with the golf course ID, the front/back nine ID and the date of play. At this time, the page sending unit 143 searches for the tee-off times in which the kind of frame is “single person reservation”, within the range of the desired tee-off time period.

Then, the golf course reservation server 1 acquires nicknames of users reserving a time frame which has already been reserved among the time frames that can be reserved (Step S22). More specifically, the page sending unit 143 acquires a reservation list corresponding to the time frame that can be reserved, from the reservation situation DB 12c. Then, the page sending unit 143 searches the reservation information DB 12d for reservation information corresponding to the reservation number registered in the reservation list. Then, the page sending unit 143 searches the member information DB 12a for member information corresponding to the user ID included in the reservation information. Then, the page sending unit 143 acquires the nickname from the member information.

Then, the shyness judging unit 141 judges if the request user is shy to make the first reservation (Step S23). More specifically, the shyness judging unit 141 acquires first reservation shyness flag from the member information corresponding to the user ID of the request user. Then, the shyness judging unit 141 makes a judgment based on the first reservation shyness flag. At this time, when the request user has been judged to be not shy to make the first reservation (Step S23: NO), the shyness judging unit 141 proceeds to Step S24. When the request user has been judged to be shy to make the first reservation (Step S23: YES), on the other hand, the shyness judging unit 141 proceeds to Step S26.

In Step S24, the page sending unit 143 generates an HTML document of the time frame selection page. More specifically, the page sending unit 143 generates the HTML document which includes the front/back nine indicators, the tee-off times of the found time frames, the numbers of reservation users, the nicknames of the users reserving the found time frames, etc. Then, the page sending unit 143 sends the generated HTML document to the user terminal 3 of the request user (Step S25). The page sending unit 143 terminates the time frame selection page sending processing, after completion of the processing of Step S25. The user terminal 3, which has received the HTML document, displays the time frame selection page as shown for example in FIG. 2A.

In Step S26, the browsing user extracting unit 142 extracts a user who has browsed the time frame detail page of the non-reserved frame, of the found time frames. More specifically, the browsing user extracting unit 142 extracts the non-reserved frame in which the number of reservation users registered in the reservation situation DB 12c is “0”, from the found time frames. Thus, the browsing user extracting unit 142 specifies the non-reserved frame based on the time frame selection page request and the reservation situation DB 12c. Then, browsing histories which includes the tee-off time of the found non-reserved frame, and the golf course ID, the front/back nine ID and the date of play included in the request are searched for. At this time, the browsing user extracting unit 142 excludes a browsing history of the request user from the browsing histories to be searched for. Then, the page sending unit 143 acquires a nickname of the user who has browsed the time frame detail page of the non-reserved frame (Step S27). More specifically, the page sending unit 143 searches the member information DB 12a for member information corresponding to a user ID included in the found browsing history. Then, the page sending unit 143 acquires the nickname from the member information. Then, the page sending unit 143 generates an HTML document of a time frame selection page (Step S28). More specifically, the page sending unit 143 generates the HTML document which includes the front/back nine indicators, the tee-off times of the found time frames, the numbers of reservation users, the nicknames of the users reserving the found time frames, the nickname of the user who has browsed the time frame selection page of the non-reserved frame, etc. Then, the page sending unit 143 proceeds to Step S25. Then, the page sending unit 143 sends the generated HTML document. The user terminal 3, which has received the HTML document, displays the time frame selection page as shown for example in FIG. 4A.

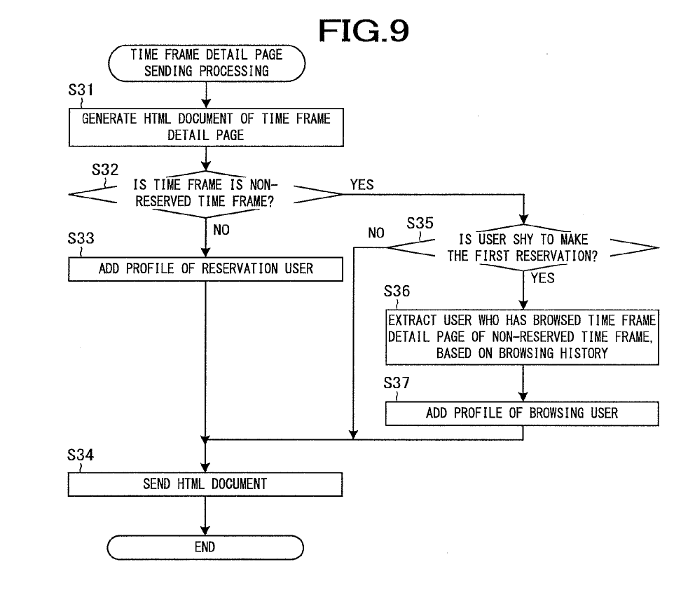

FIG. 9 is a flowchart showing the processing example of the time frame detail page sending processing, by the system control unit 14 of the golf course reservation server 1 according to the embodiment of the present invention. The system control unit 14 executes the time frame detail page sending processing, when receiving the time frame detail page request from the user terminal 3. The time frame detail page request includes, for example, a golf course ID. A plan ID, a front/back nine ID, a date of play, a tee-off time, a user ID of the request user, etc. The golf course ID, the plan ID, the front/back nine ID and the date of play included in the time frame detail page request are the same as the golf course ID, the plan ID, the front/back nine ID and the date of play included in the time frame selection page request, respectively. The tee-off time indicates the time frame which has been selected by the request user on the time frame selection page. The non-reserved frame is specified based on the golf course ID, the front/back nine ID, the date of play and the tee-off time included in the time frame detail page request. The time frame detail page request is an example of the request of the present invention.

As shown in FIG. 9, the page sending unit 143 generates an HTML document of the time frame detail page (Step S31). More specifically, the page sending unit 143 searches the golf course information DB 12b for golf course information corresponding to the golf course ID. Then, the page sending unit 143 acquires information of a plan name, contents of a plan, a playing fee, a front/back nine indicator, etc. which correspond to the golf course name, the plan ID and the front/back nine ID, from the golf course information. Then, the page sending unit 143 generates the HTML document including the acquired information, the date of play, the tee-off time, etc.

Then, the page sending unit 143 judges if the time frame corresponding to the request is the non-reserved frame (Step S32). More specifically, the page sending unit 143 makes a judgment based on the number of reservation users corresponding to the golf course ID, the front/back nine ID, the date of play and the tee-off time in the reservation situation DB 12c. The page sending unit 143 proceeds to Step S33, when the time frame corresponding to the request has been judged not to be the non-reserved frame (Step S32: NO). The page sending unit 143 proceeds to Step S35, on the other hand, when the time frame corresponding to the request has been judged to be the non-reserved frame (Step S32: YES).

In Step S33, the page sending unit 143 adds a profile of a user who has reserved the time frame corresponding to the request, to the HTML document of the time frame detail page. More specifically, the page sending unit 143 acquires reservation list corresponding to the golf course ID, the front/back nine ID, the date of play and the tee-off time from the reservation situation DB 12c. Then, the page sending unit 143 searches for reservation information corresponding to the reservation number registered in the reservation list, from the reservation information DB 12d. Then, the page sending unit 143 acquires a user ID, a playing style, a self-introduction and a spirit from the reservation information. Then, the page sending unit 143 searches the member information DB 12a for member information corresponding to the user ID acquired from the reservation information DB 12d. Then, the page sending unit 143 acquires a nickname, a birth date, a gender and an average score from the member information. Then, the page sending unit 143 generates the profile based on the information acquired from each of the reservation information and the member information. Then, the page sending unit 143 adds the generated profile to the HTML document. Then, the page sending unit 143 sends the HTML document to which the profile has been added, to the user terminal 3 of the request user (Step S34). The page sending unit 143 terminates the time frame detail page sending processing, after completion of the processing of Step S34.

In Step S35, the shyness judging unit 141 judges if the request user is shy to make the first reservation. A method of making the judgment is the same as that of Step S34 in the time frame selection page sending processing. The shyness judging unit 141 proceeds to Step S34, when the request user is judged as not being shy to make the first reservation (Step S35: NO). Then, the page sending unit 143 sends the generated HTML document. The user terminal 3, which has received the HTML document, displays the time frame detail page as shown for example in FIG. 2B. The shy judging unit 141 proceeds to Step S36, on the other hand, when the request user is judged as being shy to make the first reservation (Step S35: YES).

In Step S36, the browsing user extracting unit 142 extracts a user who has browsed the time frame detail page of the non-reserved frame corresponding to the request. More specifically, the browsing user extracting unit 142 searches for browsing histories including the golf course ID, the plan ID, the front/back nine ID and the date of play included in the request. At this time, the browsing user extracting unit 142 excludes a browsing history of the request user from browsing histories to be searched for. Then, the page sending unit 143 adds a profile of the user who has browsed the time frame detail page of the non-reserved frame corresponding to the request, to the HTML document of the time frame detail page (Step S37). More specifically, the page sending unit 143 searches the member information DB 12a for member information corresponding to a user ID included in the found browsing history. Then, the page sending unit 143 acquires a nickname, a birth date, a gender and an average score from the member information. Then, the page sending unit 143 generates a profile based on the information acquired from the member information. Then, the page sending unit 143 adds the generated profile to the HTML document. Then, the page sending unit 143 proceeds to Step S34. Then, the page sending unit 143 sends the HTML document to which the profile has been added. The user terminal 3, which has received the HTML document, displays the time frame detail page as shown for example in FIG. 4B. By sending the HTML document to the user terminal 3, the page sending unit 143 causes the user terminal 3 to present the profile of the user who browsed the non-reserved frame.

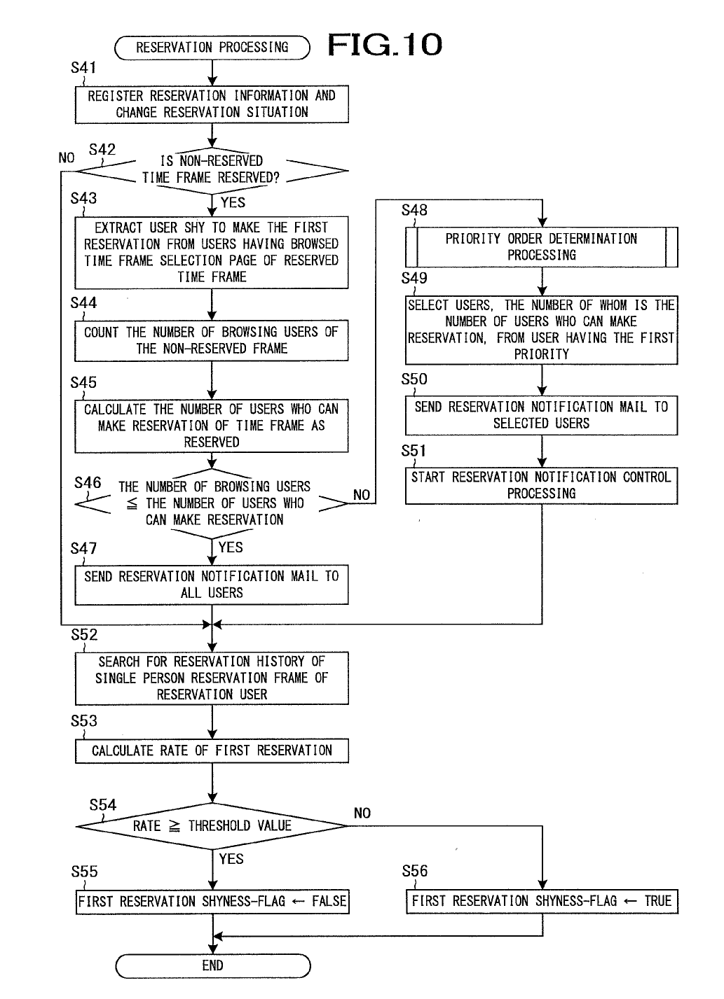

FIG. 10 is a flowchart showing the processing example of the reservation processing by the system control unit 14 of the golf course reservation server 1 according to the embodiment of the present invention. The system control unit 14 executes the reservation processing when receiving the reservation request from the user terminal 3. The reservation request may include, for example, a golf course ID, a plan ID, a front/back nine ID, a date of play, a tee-off time, a playing style, self-introduction, spirit, a user ID of the request user, etc. The golf course ID, the plan ID, the front/back nine ID, the date of play and the tee-off time indicate the golf course, the plan, the front/back nine, the date of pay and the time frame, to be reserved. The playing style, the self-introduction, the spirit, etc. are inputted by the user.

As shown in FIG. 10, the reservation processing unit 144 registers reservation information and changes a reservation situation (Step S41). More specifically, the reservation processing unit 144 generates a new reservation number. In addition, the reservation processing unit 144 acquires the current date and time as the reservation date and time. Then, the reservation processing unit 144 generates the reservation information which includes the reservation number, the reservation date and time, the kind of frame set as the “single person reservation frame”, the information included in the reservation request, etc. Then, the reservation processing unit 144 registers the generated reservation information in the reservation information DB 12d. Then, the reservation processing unit 144 adds “1” to the number of reservation users corresponding to the golf course ID, the front/back nine ID, the date of play and the tee-off time, in the reservation situation DB 12c and adds the reservation number to the reservation list.

Then, the reservation notification unit 145 judges if the reserved time frame was the non-reserved frame (Step S42). When the number of reservation users after the update is equal to or larger than “2”, the reservation notification unit 145 judges the reserved time frame not to be the non-reserved frame (Step S42: NO). In this case, the reservation notification unit 145 proceeds to Step S52. When the number of reservation users after update is “1”, the reservation notification unit 145 judges the reserved time frame to be the non-reserved frame (Step S42: YES). In this case, the reservation communication proceeds to Step S43.

In Step S43, the reservation notification unit 145 extracts users who are shy to make the first reservation, of users who have browsed a time frame detail page of the reserved time frame. More specifically, the reservation notification unit 145 searches for browsing histories which includes the golf course ID, the front/back nine ID, the date of play and the tee-off time included in the reservation request. At this time, the reservation notification unit 145 excludes a browsing history of the request user from the browsing histories to be searched for. Then, the reservation notification unit 145 acquires user IDs from the respective found browsing histories. Then, the reservation notification unit 145 acquires first reservation shyness flags from the member information corresponding to the acquired user IDs. Then, the reservation notification unit 145 extracts user IDs in which the first reservation shyness flags are “TRUE”. Then, the reservation notification unit 145 generates a notification subject list of the extracted users.

Then, the reservation notification unit 145 calculates the number of browsing users of the non-reserved frame by counting the number of the extracted users (Step S44). Then, the reservation notification unit 145 calculates the number of users who can make reservation of time frame by subtracting the number of reservation users after the update from the maximum number of participants by which the event can be held, of the reserved time frame (Step S45). Then, the reservation notification unit 145 judges if the number of browsing users of the non-reserved frame is equal to or smaller than the number of users who can make reservation of time frame (Step S46). When the number of browsing users of the non-reserved frame has been judged to be equal to or smaller than the number of users who can make reservation of time frame (Step S46: YES), the reservation notification unit 145 proceeds to Step S47. When the number of browsing users of the non-reserved frame has been judged to be larger than the number of users who can make reservation of time frame (Step S46: NO), on the other hand, the reservation notification unit 145 proceeds to Step S48.

In Step S47, the reservation notification unit 145 sends the reservation notification mail to all of the extracted users. More specifically, the reservation notification unit 145 acquires a mail address from member information of the extracted user. Then, the reservation notification unit 145 generates the reservation notification mail. At this time, the reservation notification unit 145 adds the acquired mail address as a receiver address of the reservation notification mail. In addition, the reservation notification unit 145 adds a message informing that the non-reserved frame has been reserved, and the golf course, the plan, the date of play, the tee-off time and the link which are reserved, to the body of the reservation notification mail. The reservation notification unit 145 sends the generated reservation notification mail. The reservation notification unit 145 generates and sends the reservation notification mail for all the extracted users. Then, the reservation notification unit 145 proceeds to Step S52.

In Step S48, the reservation notification unit 145 performs the priority order determination processing. The priority order determination processing is to determine the priority order of the users to be informed of the reservation. Then, the user IDs registered in the notification subject list are rearranged in the priority order. The detail of the priority order determination processing will be described later. Then, the reservation notification unit 145 selects users, the number of whom corresponds to the number of users who can make reservation of time frame, in the priority order from the user having the first priority (Step S49). Then, the reservation notification unit 145 deletes the selected user IDs from the notification subject list. Then, the reservation notification unit 145 sends the reservation notification mail to the selected users (Step S50). The contents of this processing are the same as those in Step S47. Then, the reservation notification unit 145 causes the reservation notification control processing to be started (Step S51). In the reservation notification control processing, the reservation notification mail is sent to a user who is shy to make the first reservation and has browsed the time frame detail page of the reserved time frame, at every time when a predetermined time lapses. The reservation notification control processing is performed in a different process from the process of the reservation processing. The detail of the reservation notification control processing will be described later. When the reservation notification control processing starts, the reservation notification unit 145 proceeds to Step S52.

In Step S52, the shyness judging unit 141 searches for the reservation information of the single person reservation frame of the request user. More specifically, the shyness judging unit 141 searches the reservation information DB 12d for the reservation information which includes the user ID of the request user and the kind of frame set as the “single person reservation frame”. Then, the shyness judging unit 141 calculates a rate of the first reservation made by the request user, of the reservations made by the request user (Step S53). More specifically, the shyness judging unit 141 selects one piece of the found reservation information. Then, the shyness judging unit 141 acquires the golf course ID, the plan ID, the front/back nine ID, the date of play and the tee-off time from the piece of the reservation information. Then, the shyness judging unit 141 searches the reservation information DB 12d for the reservation information including the acquired information. As a result, the shyness judging unit 141 specifies the other users who have reserved the same time frame as the time frame reserved by the request user. Then, the shyness judging unit 141 acquires a reservation date and time from respective pieces of the reservation information. Then, the shyness judging unit 141 judges if the reservation date and time of the request user, of the acquired reservation dates and times as acquired. When the reservation date and time of the request user is the earliest, the shyness judging unit 141 judges that the request user has made the first reservation. When the reservation date and time by the request user is not the earliest, on the other hand, the shyness judging unit 141 judges that the request user has made the second or subsequent reservation. The shyness judging unit 141 selects sequentially pieces of the reservation information of the request user and judges if the request user has made the first reservation. Thus, the shyness judging unit 141 counts the number of first reservations made by the request user. Then, the shyness judging unit 141 calculates the rate of the first reservation made by the request user, by dividing the number of the first reservations by the number of the reservations of the single person reservation frame by the request user.

Then, the shyness judging unit 141 judges if the calculated rate is equal to or larger than the threshold value stored in the storage unit 12 (Step S54). When the rate as calculated is judged to be equal to or larger than the threshold value (Step S54: YES), the shyness judging unit 141 proceeds to Step S55. When the rate as calculated is judged to be smaller than the threshold value (Step S54: NO), on the other hand, the shyness judging unit 141 proceeds to Step S56.

In Step S55, the shyness judging unit 141 sets the first reservation shyness flag of the request user as “FALSE”, in the member information DB 12a. In Step S56, the shyness judging unit 141 sets the first reservation shyness flag of the request user as “TRUE”, in the member information DB 12a. The shyness judging unit 141 terminates the reservation processing, after completion of Steps S55 or S56.

Now, description will be given of the priority order determination processing by the system control unit 14 of the golf course reservation server 1. The contents of the priority order determination processing depend on the determining methods of the priority order determination processing. Thus, description will be given below for each of the determining methods.

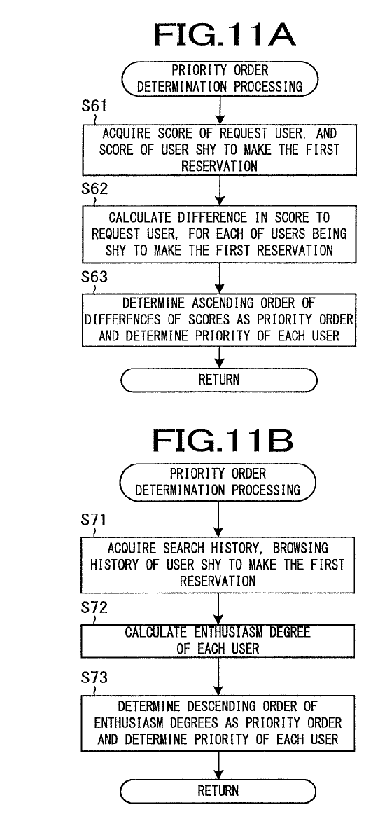

FIG. 11A is a flowchart showing the processing example of the priority order determination processing in a case where the priority order is determined based on skills of the user at golf. As shown in FIG. 11A, The reservation notification unit 145 acquires an average score of the request user and an average score of each of the users extracted through the reservation processing, from the member information DB 12a (Step S61). Then, the reservation notification unit 145 calculates, for each of the extracted users, a difference between the average score of the request user and the average score of the extracted user (Step S62). Then, the reservation notification unit 145 determines ascending order of the differences for the average scores of the users, as the priority order of the users to be informed of the reservation (Step S63). Then, the reservation notification unit 145 rearranges the user IDs registered in the notification subject list in the determined priority order. The reservation notification unit 145 terminates the priority order determination processing, after completion of Step S63.

FIG. 11B is a flowchart showing the processing example of the priority order determination processing in a case where the priority order is determined based on operation histories. As shown in FIG. 11B, the reservation notification unit 145 acquires a search history and a browsing history of each of the extracted user through the reservation processing (Step S71). More specifically, the reservation notification unit 145 selects one of the extracted users. Then, the reservation notification unit 145 acquires, as the browsing date and time, the operation date and time of the browsing history of the time frame detail page of the notification subjected frame, of the selected user. Then, the reservation notification unit 145 searches the operation history DB 12e for operation histories which includes a user ID of the selected user. Then, the reservation notification unit 145 extracts log-in histories to the reservation site and log-out histories of it, from the found operation histories. Then, the reservation notification unit 145 acquires operation dates and times of the extracted histories, as log-in dates and times, and log-out dates and times. Then, the reservation notification unit 145 selects a log-in date and time which is the closest to the browsing date and time of the time frame detail page of the notification subjected frame, from the log-in dates and times which are prior to the browsing date and time. In addition, the reservation notification unit 145 selects a log-out date and time which is the closest to the browsing date and time of the time frame detail page of the notification subjected frame, from the log-out dates and times which are posterior to the browsing date and time. Then, the reservation notification unit 145 extracts the search histories and the browsing histories of the time frame detail page, among operation histories which includes an operation date and time between the log-in date and time, and the log-out date and time. The log-in date and time is a date and time when the user has started to use the reservation site. The log-out date and time is a date and time when the user has ended the user of the reservation site. So, the reservation notification unit 145 acquires the histories of the operation which has been made by the user at the same period of time as the browsing of the time frame detail page of the notification subjected frame, among the operations made by the user during a period between the start and the end of use of the reservation site by the user. There may be a case where the user is still currently logging in to the reservation site even after the browsing of the time frame detail page of the notification subjected frame. In this case, the log-out date and time cannot be specified. So, in such a case, the reservation notification unit 145 extracts search histories and the browsing histories of the time frame detail page after the log-in date and time. The reservation notification unit 145 selects the users in the order and acquires the search histories and the browsing histories.

Then, the reservation notification unit 145 calculates tenacity degree of each of the users, based on the acquired histories. More specifically, the reservation notification unit 145 selects one of the users selected through the reservation processing. Then, the reservation notification unit 145 sets by default the tenacity degree of the selected user, as for example “0”. Then, the reservation notification unit 145 acquires, from the search history of the selected user, a name of a golf course, a date of play, and a desired tee-off time period which have been designated as the search conditions. If there is a plurality of search histories, the reservation notification unit 145 performs the acquiring processing for each of the search histories. Then, the reservation notification unit 145 acquires a name of the golf course corresponding to the notification subjected frame, from the golf course information DB 12b. When the name of the golf course corresponding to the notification subjected frame coincides with the name of the golf course designated as the search condition, the reservation notification unit 145 adds then a preset first additional value to the tenacity degree. When the date of play corresponding to the notification subjected frame coincides with the date of play designated as the search condition, the reservation notification unit 145 adds then a preset second additional value to the tenacity degree. When the tee-off time corresponding to the notification subjected frame is included in the desired tee-off time period, the reservation notification unit 145 adds then a preset third additional value to the tenacity degree. Incidentally, each of the first to third additional values may be set as freely determined values.

Then, the reservation notification unit 145 specifies, from the browsing histories of the selected user, a golf course, a date of play and a tee-off time displayed on the webpage which has been browsed by the user. For example, the golf course may be specified from the browsing history of the golf course page. Further, the golf course and the date of play may be specified from the browsing history of the time frame selection page. Further, the golf course, the date of play and the tee-off time may be specified from the browsing history of the time frame detail page. Then, the reservation notification unit 145 calculates a rate of browsing a webpage on which information on the golf course corresponding to the notification subjected frame is displayed, a rate of browsing a webpage on which information on the date of play corresponding to the notification subjected frame is displayed, and a rate of browsing a webpage on which information on a time frame of the same tee-off time as the tee-off time of the notification subjected frame is displayed, among webpages which have been browsed by the selected user. Then, the reservation notification unit 145 determines, based on each of the calculated rates, an additional value which is to be added to the tenacity degree. At this time, the larger each of the calculated rates is, the larger additional value the reservation notification unit 145 determines. Then, the reservation notification unit 145 adds the determined additional value to the tenacity degree.

The reservation notification unit 145 selects the users in the order and calculates the tenacity degrees. The method as described here is an example of determining the tenacity degree based on the operation history. The reservation notification unit 145 may determine the tenacity degree in the different manner based on the operation history.

Then, the reservation notification unit 145 makes a comparison in the calculated tenacity degree between the users. Then, the reservation notification unit 145 determines descending order of the tenacity degrees, as the priority order of the users to be informed of the reservation (Step S73). Then, the reservation notification unit 145 rearranges the user Ids registered in the notification subject list, in the determined priority order. The reservation notification unit 145 terminates the priority order determination processing, after completion of Step S73.

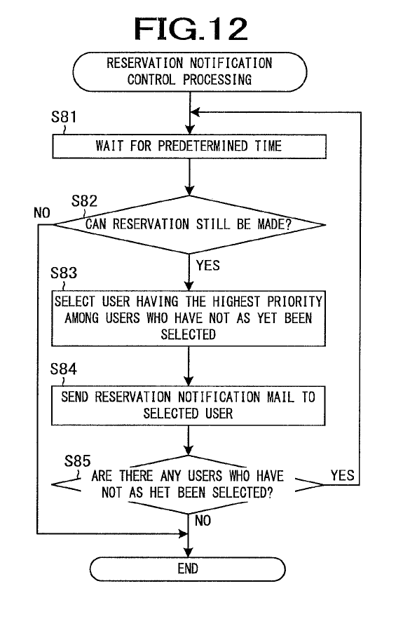

FIG. 12 is a flowchart showing the processing example of the reservation notification control processing by the system control unit 14 of the golf course reservation server 1 according to the embodiment of the present invention. As shown in FIG. 12, the reservation notification unit 145 waits for a preset time (Step S81). After the waiting, the reservation notification information 145 judges if the notification subjected frame can still be reserved (Step S82). More specifically, when the deadline date and time for the reservation of the notification subjected frame has already passed, the reservation notification unit 145 judges the reservation to be unavailable. When the number of reservation users of the notification subjected frame, registered in the reservation situation DB 12c, coincides with the maximum number of participants by which the event can be held, the reservation notification unit 145 judges the reservation to be unavailable. The reservation notification unit 145 terminates the reservation notification control processing, when the reservation has been judged to be unavailable (Step S82: NO). When the deadline date and time has not as yet passed, and the number of reservation users is smaller than the maximum number of participants by which the event can be held, the reservation notification unit 145 judges the reservation to be available, on the other hand. In this case, the reservation notification unit 145 proceeds to Step S83.

In Step 83, the reservation notification unit 145 selects a user having the highest priority, from the users who have not as yet been selected, who were extracted through the reservation processing (Step S83). At this time, the reservation notification unit 145 deletes the user ID of the selected user from the notification subject list. Then, the reservation notification unit 145 sends the reservation notification mail to the selected user (Step S84). Then, the reservation notification unit 145 judges if the extracted users include any user who has not as yet been selected (Step S85). When it is determined that there is the user who has not as yet been selected (Step S85: YES), the reservation notification unit 145 proceeds to Step S81. When all the users have been judged to be already selected (Step S85: NO), the reservation notification unit 145 terminates the reservation notification control processing.

In accordance with the embodiments of the present invention as described above, the system control unit 14 judges a user who is shy to make the first reservation, based on the reservation information stored in the storage unit 12. Then, the system control unit 14 acquires, from the storage unit 12, a browsing history of a time frame detail page of a non-reserved frame which is specified based on a request from the user who has been judged to be shy to make the first reservation. Then, the system control unit 14 extracts another user who has browsed the time frame detail page of the specified non-reserved frame, based on the browsing history. Then, the system control unit 14 causes at least a part of the profile of the extracted user to be presented in association with the non-reserved frame in which the time frame detail page has been browsed by this extracted user, to the user who is shy to make the first reservation. Thus, it is possible to provide the user with the information for making the decision of reservation not so as to hesitate to reserve the non-reserved frame.

In addition, when the user, who was judged to be shy to make the first reservation, browsed the time frame detail page of the non-reserved frame, and then, this time frame has been reserved by another user, the system control unit 14 outputs information of informing the user who is shy to make the first reservation that this time frame has been reserved. Therefore, it is possible to encourage the user who is shy to make the first reservation to make the second or subsequent reservation to.

In addition, when the number of browsing users of the non-reserved frame is larger than the number of reservation users, the system control unit 14 determines the priority order of the users who are to be informed of the reservation of the time frame. Then, the system control unit 14 outputs the notification information in the priority order. Therefore, it is possible to avoid a case where the user cannot make the reservation, in spite of receiving the information, due to the fact that the number of user who reserved this time frame has amounted to the maximum number of participants.

In addition, the system control unit 14 acquires the average score of the user who is shy to make the first reservation, and the average score of the other user who has reserved the non-reserved frame, from the storage unit 12. Then, the system control unit 14 determines the priority order so as to inform preferentially a user whose level of the average score is the same as that of the user who has reserved the non-reserved frame. It is therefore possible to provide a higher probability of making the reservation, while avoiding a case where the user who received the information cannot make the reservation.

In addition, the system control unit 14 acquires the operation history of the user who is shy to make the first reservation, from the storage unit 12. Then, the system control unit 14 determines, based on the operation history, the tenacity degree of the user, for at least one of the golf course, the date of play and the time frame for the tee-off time corresponding to the non-reserved frame which has been reserved. Then, the control unit 14 determines the higher priority for the user having the higher tenacity degree. It is therefore possible to provide a higher probability of making the reservation, while avoiding a case where the user who received the information cannot make the reservation.

In each of the embodiments of the present invention as described above, the present invention is applied to the golf as the event. However, the present invention may be applied to an event which is different from the golf.

In addition, in each of the embodiments of the present invention as described above, the information processing apparatus of the present invention is applied to the server device in a client server system. However, the information processing apparatus of the present invention may be applied to the other information processing device than the server device. For example, the information processing apparatus of the present invention may be applied to the user terminal 3, etc. Then, for example, a control unit included in the information processing apparatus may function as the means of the present invention, so that the control unit causes the profile to be displayed on the display means such as the display unit, and outputs the information of informing that the time frame has been reserved. In this case, the display means may be provided by the information processing apparatus. Alternatively, the display means may be an independent device from the information processing apparatus.

### DESCRIPTION OF REFERENCE NUMERALS

1 Golf course reservation server
2 Golf course terminal
3 User terminal
11 Communication unit
12 Storage unit
12a Member information DB
12b Golf course information DB
12c Reservation situation DB
12d Reservation information DB
12e Operation history DB
13 Input and output interface
14 System control unit
14a CPU
14b ROM
14c RAM
15 System bus
141 Shyness judging unit
142 Browsing user extracting unit
143 Page sending unit
144 Reservation processing unit
145 Reservation notification unit
NW Network
S Information processing system

1-7. (canceled)

8. An information processing apparatus comprising:
at least one memory operable to store program instructions;
at least one processor operable to access said at least one memory and read said program instructions, said program instructions causing at least one of said at one processors to:
judge, based on a reservation history of a reservation frame of an event in which a plurality of users can participate, a user who is shy to make a reservation of a reservation frame which has not been reserved by any person, the reservation history being stored in a reservation history storage storing a reservation history of each reservation frame so that order of users who has reserved the reservation frame can be specified;
acquire, from a browsing history storage storing a browsing history including information indicating a user who has browsed reservation frame information on the reservation frame, a browsing history of a reservation frame which has not been reserved by any person and which is specified based on a request, for the reservation frame information, from a first user who is judged to be shy to make the reservation of the reservation frame which has not been reserved by any person;
extract, based on the browsing history acquired, a second user who has browsed the reservation frame information of the reservation frame specified based on the request, from among other users than the first user; and
cause at least a part of a profile of the second user extracted to be presented to the first user in association with the reservation frame whose reservation frame information has been browsed by the second user.

9. The information processing apparatus according to claim 8, said program instructions further causing at least one of said at least one processors to:
output a notification information of informing the first user that the reservation frame has been reserved, when the reservation frame which had not been reserved by any person was reserved by a third user who is different from the first user after the first user browsed the reservation frame information of the reservation frame.

10. The information processing apparatus according to claim 9, said program instructions further causing at least one of said at least one processors to:
determine priority order of the first users who are to be informed that the reservation frame has been reserved, when a number of first users who browsed the reservation frame information of the reservation frame which has been reserved by the third user, prior to the reservation of the reservation frame, is larger than a number of users who can currently reserve the reservation frame, and
wherein:
at least one of said at least one processors outputs the notification information based on the priority order determined.

11. The information processing apparatus according to claim 10, wherein:
the event is a game played by a plurality of users; and
said program instructions further cause at least one of said at least one processors to acquire, from a skill information storage storing skill information indicating skills of users at the game, skill information of the first users and skill information of the third user, and
wherein:
the program instructions cause at least one of said processors to determine, based on the skill information acquired, the priority order so that a first user having a level of the skills which is the same as a level of the skills of the third user is preferentially informed.

12. The information processing apparatus according to claim 10, wherein said program instructions further cause at least one of said processors to:
acquire, from an operation history storage storing an operation history of a user on a website in which a reservation frame available can be searched for, operation histories of the first users; and
determine, based on the operation histories acquired, tenacity degrees of the first users for at least any one of a place where the event corresponding to the reservation frame reserved by the third user is to be held and a time when the event is to be started,
wherein:
the higher a tenacity degree determined for a first user is, the higher the priority the processor determines for the first user.

13. The information processing apparatus according to claim 11, said program instructions further causing at least one processor to:
acquire, from an operation history storage storing an operation history of a user on a website in which a reservation frame available can be searched for, operation histories of the first users; and
determine, based on the operation histories acquired, tenacity degrees of the first users for at least any one of a place where the event corresponding to the reservation frame reserved by the third user is to be held and a time when the event is to be started,
wherein:
the higher an tenacity degree determined for a first user is, the higher the priority the processor determines for the first user.

14. An information processing method to be executed by a computer comprising:
judging, based on a reservation history of a reservation frame of an event in which a plurality of users can participate, a user who is shy to make a reservation of a reservation frame which has not been reserved by any person, the reservation history being stored in a reservation history storage storing a reservation history of each reservation frame so that order of users who has reserved the reservation frame can be specified;
acquiring, from a browsing history storage storing a browsing history including information indicating a user who has browsed reservation frame information on the reservation frame, a browsing history of a reservation frame which has not been reserved by any person and which is specified based on a request, for the reservation frame information, from a first user who is judged to be shy to make the reservation of the reservation frame which has not been reserved by any person;
extracting, based on the browsing history acquired, a second user who has browsed the reservation frame information of the reservation frame specified based on the request, from among other users than the first user; and
causing at least a part of a profile of the second user extracted to be presented to the first user in association with the reservation frame whose reservation frame information has been browsed by the second user.

15. A non-transitory computer readable medium storing thereon an information processing program, the information processing program causing a computer to:
judge, based on a reservation history of a reservation frame of an event in which a plurality of users can participate, a user who is shy to make a reservation of a reservation frame which has not been reserved by any person, the reservation history being stored in a reservation history storage storing a reservation history of each reservation frame so that order of users who has reserved the reservation frame can be specified;
acquire, from a browsing history storage storing a browsing history including information indicating a user who has browsed reservation frame information on the reservation frame, a browsing history of a reservation frame which has not been reserved by any person and which is specified based on a request, for the reservation frame information, from a first user who is judged to be shy to make the reservation of the reservation frame which has not been reserved by any person;
extract, based on the browsing history acquired, a second user who has browsed the reservation frame information of the reservation frame specified based on the request, from among other users than the first user; and
cause at least a part of a profile of the second user extracted to be presented to the first user in association with the reservation frame whose reservation frame information has been browsed by the second user.
